(19) United States
(12) Patent Application Publication
(10) Pub. No.: US 2021/0068208 A1
(43) Pub. Date: Mar. 4, 2021

(54) COOKING APPARATUS AND METHOD FOR CONTROLLING THE SAME

(71) Applicants: Samsung Electronics Co., Ltd., Suwon-si (KR); Research & Business Foundation SUNGKYUNKWAN UNIVERSITY, Suwon-si (KR)

(72) Inventors: Dongoh KANG, Suwon-si (KR); Sangmin PARK, Suwon-si (KR); Byoungkuk LEE, Suwon-si (KR); Hyomin AHN, Suwon-si (KR); Eunsu JANG, Suwon-si (KR); Changsun YUN, Suwon-si (KR); Taeho LEE, Suwon-si (KR)

(21) Appl. No.: 17/010,741

(22) Filed: Sep. 2, 2020

(30) Foreign Application Priority Data
Sep. 2, 2019 (KR) 10-2019-0108013

(51) Int. Cl. H05B 6/06; H05B 6/44; H05B 6/36

(52) U.S. Cl. CPC H05B 6/065; H05B 6/062; H05B 6/44; F24C 7/083; H05B 2213/05; H05B 2213/03; H05B 6/36

(57) ABSTRACT

A cooking apparatus and a method for controlling the same. The cooking apparatus may include a heating coil operable by an induction heating method, an inverter configured to provide a driving power to the heating coil, a sensing coil positioned at an upper portion or a lower portion of the heating coil, a sensing circuit configured to provide a test power to an end of the sensing coil and sense a magnitude of power that is output at other end of the sensing coil, and a processor configured to identify whether an object to be heated is disposed at an upper portion of the sensing coil based on the magnitude of power sensed by the sensing circuit, and based on the disposition of the object to be heated being identified, control the inverter to apply the driving power to the heating coil.

### CROSS-REFERENCE TO RELATED APPLICATION

This application is based on and claims priority under 35 U.S.C. § 119 to Korean Patent Application No. 10-2019-0108013 filed on Sep. 2, 2019 in the Korean Intellectual Property Office, the disclosure of which is incorporated by reference herein in its entirety.

### BACKGROUND

### 1. Field

The disclosure relates to a cooking apparatus and a method for controlling thereof and, more specifically, to a cooking apparatus capable of quickly identifying a location and a size of a container on a cooking apparatus including a plurality of inductors, and providing a low power sensing circuit having low energy consumption and a control algorithm and a method for controlling thereof.

### 2. Description of Related Art

An induction heating (IH) method is a method of heating a metal using an electron induction phenomenon of the Faraday, wherein an object to be heated, which is a metal material, generates an eddy current by an organic electromotive force, and the eddy current flowing inside a conductor is converted into thermal energy by Joule's law by generating eddy current loss due to a resistance of a surface part.

Generally, an IH cooking apparatus is a cooking apparatus for heating a cooking container using the principle of IH. The IH cooking apparatus may include a cooking table on which a cooking container is placed and an IH coil for generating a magnetic field when a current is applied.

The IH cooking apparatus has an advantage that it may provide rapid heating, generate no harmful gas, and have no risk of fire occurrence as compared to a gas range or a fuel oil stove which combusts a fossil fuel such as a gas or oil and heats a cooking container through the combustion heat.

However, a related art uses an inverter for an inductor (heating coil) for heating a container by directly flowing current to generate a magnetic flux and senses a parameter value to determine (or identify) a location and a size of the container. In a cooking apparatus composed of a plurality of inductors, if one or more inverters flow current to one or more inductors while keeping operating, there is a disadvantage that a huge amount of power may be consumed.

### SUMMARY

Embodiments of the disclosure may address the above problems, and may provide a cooking apparatus capable of rapidly identifying a location and a size of a container on a cooking apparatus including a plurality of inductors and providing a low power sensing circuit with low power assumption and control algorithm and a method for controlling thereof.

A cooking apparatus according to an embodiment may include a heating coil operable by an induction heating method, an inverter configured to provide a driving power to the heating coil, a sensing coil positioned at an upper portion or a lower portion of the heating coil, a sensing circuit configured to provide a test power to an end of the sensing coil and sense a magnitude of power that is output at other end of the sensing coil, and a processor configured to identify whether an object to be heated is disposed at an upper portion of the sensing coil based on the magnitude of power sensed by the sensing circuit, and based on the disposition of the object to be heated being identified, control the inverter to apply the driving power to the heating coil.

The processor may, based on the magnitude of power sensed by the sensing circuit exceeding a reference power value in a predetermined frequency range, determine that the object to be heated is disposed.

The processor may control the sensing circuit for identifying whether the object to be heated is disposed while the driving power is applied to the heating coil, and based on identification that the object to be heated is not disposed, control the inverter to block the driving power applied to the heating coil.

The heating coil is configured such that a plurality of heating coils are disposed in a grid form, and the sensing coil is configured such that a plurality of sensing coils are disposed in a grid form.

The processor may identify a location of the object to be heated based on the magnitude of power that is output from each other end of the plurality of sensing coils, and control the inverter so that a driving power is applied to the heating coil corresponding to the identified location of the object to be heated.

A number of the sensing coil may be identical with a number of the heating coils, and each of the sensing coil may be disposed at an upper portion or a lower portion of corresponding heating coils.

The number of the sensing coil may be less than the number of the heating coils, and each of the sensing coils may be disposed at an upper portion or a lower portion of different heating coils so as not to overlap with each other.

The cooking apparatus may further include an input interface configured to receive an input of a heating level of the cooking apparatus, and the processor may calculate driving power for each of the plurality of corresponding heating coils so that the plurality of heating coils corresponding to the identified location of the object to be heated have the input heating level, and control the inverter so that the calculated driving power is applied to each of the plurality of corresponding heating coils.

The processor may, based on the identified location of the object to be heated moving while the calculated driving power is applied, control the inverter to cause the heating coil corresponding to the moved location to have a same heating level as before the object to be heated is moved.

The sensing coil may be in one of a spiral, circular, or polygonal shape.

The sensing coil may be formed with a number of turns that are less than or equal to a number of turns of the heating coil.

According to an embodiment, a method for controlling a cooking apparatus comprising a heating coil and a sensing coil may include providing a test power from a sensing circuit to an end of the sensing coil and sensing a magnitude of power that is output at other end of the sensing coil; identifying whether an object to be heated is disposed at an upper portion of the sensing coil based on the magnitude of power sensed by the sensing circuit; and based on the disposition of the object to be heated being identified, applying the driving power to the heating coil.

The identifying may include, based on the magnitude of power sensed by the sensing circuit exceeding a reference power value in a predetermined frequency range, determining that the object to be heated is disposed.

The method may further include identifying whether the object to be heated is disposed while the driving power to the heating coil is applied and based on identification that the object to be heated is not disposed, blocking the driving power applied to the heating coil.

The heating coil may be configured such that a plurality of heating coils are disposed in a grid form, and the sensing coil may be configured such that a plurality of sensing coils are disposed in a grid form.

The applying may include identifying a location of the object to be heated based on the magnitude of power that is output from each other end of the plurality of sensing coils, and applying a driving power to the heating coil corresponding to the identified location of the object to be heated.

A number of the sensing coil may be identical with a number of the heating coils, and each of the sensing coil may be disposed at an upper portion or a lower portion of corresponding heating coils.

The number of the sensing coil may be less than the number of the heating coils, and each of the sensing coils may be disposed at an upper portion or a lower portion of different heating coils so as not to overlap with each other.

The method may further include receiving an input of a heating level of the cooking apparatus, and the applying may include calculating driving power for each of the plurality of corresponding heating coils so that the plurality of heating coils corresponding to the identified location of the object to be heated have the input heating level, and applying the calculated driving power to each of the plurality of corresponding heating coils.

The applying may include, based on the identified location of the object to be heated moving while the calculated driving power is applied, applying the drawing power to cause the heating coil corresponding to the moved location to have a same heating level as before the object to be heated is moved.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is an example diagram illustrating an outer appearance of a cooking apparatus according to an embodiment;

FIG. 2A is a block diagram illustrating a configuration of a cooking apparatus according to an embodiment;

FIG. 2B is a diagram illustrating a driving circuit according to an embodiment;

FIG. 2C is a diagram illustrating a disposition of a plurality of heating coils in a grid form according to an embodiment;

FIG. 3 is a diagram illustrating a process of sensing and heating an object to be heated of a cooking apparatus according to an embodiment;

FIG. 4 is a diagram illustrating a predetermined reference power value according to an embodiment;

FIG. 5A is a diagram illustrating sensing of a foreign object according to an embodiment;

FIG. 5B is a diagram illustrating a condition for applying driving power to a heating coil according to an embodiment;

FIG. 6A is a diagram illustrating the number of sensing coils and heating coils according to an embodiment;

FIG. 6B is a diagram illustrating the number of sensing coils and heating coils according to an embodiment;

FIG. 6C is a diagram illustrating a form of a sensing coil according to an embodiment;

FIG. 7 is a diagram illustrating a driving power applied differently by the magnitude of the object to be heated according to an embodiment;

FIG. 8 is a diagram illustrating that a location of the object to be heated is moved according to an embodiment; and

FIG. 9 is a flowchart illustrating a controlling method of a cooking apparatus according to an embodiment.

### DETAILED DESCRIPTION

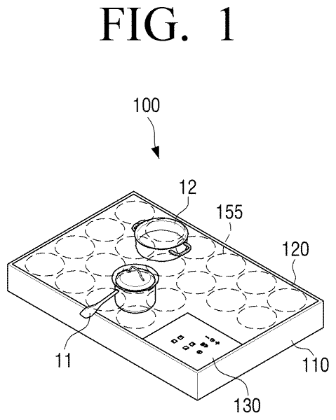

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments described herein may be variously modified. Specific embodiments are depicted in the drawings and may be described in detail in the description of the disclosure. However, it is to be understood that the particular embodiments disclosed in the appended drawings are for ease of understanding of various embodiments. Therefore, it is intended that the invention not be limited to the particular embodiments disclosed in the accompanying drawings, but on the contrary, the intention is to cover all equivalents or alternatives falling within the spirit and scope of the disclosure.

Terms such as “first,” “second,” and the like may be used to describe various components, but the components should not be limited by the terms. The terms are used to distinguish a component from another.

It is to be understood that the terms such as “comprise” or “consist of” are used herein to designate a presence of a characteristic, number, step, operation, element, component, or a combination thereof, and do not to preclude a presence or a possibility of adding one or more of other characteristics, numbers, steps, operations, elements, components or a combination thereof. It will be understood that when an element is referred to as being “coupled” or “connected” to another element, there may be other elements in the middle, although it may be directly coupled or connected to the other element. In contrast, when an element is referred to as being “directly coupled to” or “directly connected to” another element, there are no elements present therebetween.

The term such as “module,” “unit,” “part,” and so on may be used to refer to an element that performs at least one function or operation, and such element may be implemented as hardware or software, or a combination of hardware and software. Further, except for when each of a plurality of “modules,” “units,” “parts,” and the like needs to be realized in an individual hardware, the components may be integrated in at least one module. A singular expression includes a plural expression, unless otherwise specified.

When it is decided that a detailed description for the known art related to the disclosure may unnecessarily obscure the gist of the disclosure, the detailed description may be shortened or omitted. While each embodiment may be implemented or operated independently, each embodiment may be implemented or operated in combination.

The disclosure will be further described with reference to the drawings.

FIG. 1 is an example diagram illustrating an outer appearance of a cooking apparatus according to an embodiment. Referring to FIG. 1, a main body 110, a cooking plate 120, and an input interface 130 may be disposed to appear in an outside portion.

The cooking apparatus 100 may be an apparatus using an electromagnetic induction heating method. The cooking apparatus 100 may be an apparatus in which a magnetic field generated by the cooking apparatus 100 generates an induction current inside the object to be heated, and the generated induction current reacts with the resistance of the object to be heated so that the cooking apparatus 100 may cook with the generated heat.

The main body 110 may form an outer portion of the cooking apparatus 100 and parts of the cooking apparatus 100 may be mounted inside the main body 110. A plurality of heating coils 155 and a driving circuit 150 for operating with an induction heating method may be mounted inside the main body 110.

The cooking plate 120 may be disposed on one side of the main body 110 and may be formed in a planar shape so as to enable cooking of the object to be heated. The heated bodies 11 and 12 for induction heating may be placed on an upper portion of the cooking plate 120, and a plurality of heating coils 155 for induction heating of the object to be heated may be mounted at a lower portion of the cooking plate 120.

The cooking plate 120 may be composed of tempered glass such as ceramic glass so as not to be easily broken.

The object to be heated 11 and 12 placed on an upper portion of the cooking plate 120 may be disposed regardless of a location, and the object to be heated 11 and 12 may be sensed by a sensing coil and a sensing circuit to be described later and may be induction-heated by a plurality of heating coils mounted at a lower portion of the cooking plate 120.

The cooking apparatus 100 may include the input interface 130 for receiving a user command. Specifically, the input interface 130 may receive an operation command of the cooking apparatus 100. The operation command may include a heating level selection command, an operation start command, and an operation reservation command. The input interface 130 may include a touch panel, and the touch panel may be formed of a touch screen integrally provided with the display panel.

The input interface 130 may be provided at one side of the main body 110. FIG. 1 illustrates that the input interface 130 is disposed at an upper portion of the main body 110, but the input interface 130 may be disposed at a front surface or a side surface of the main body 110.

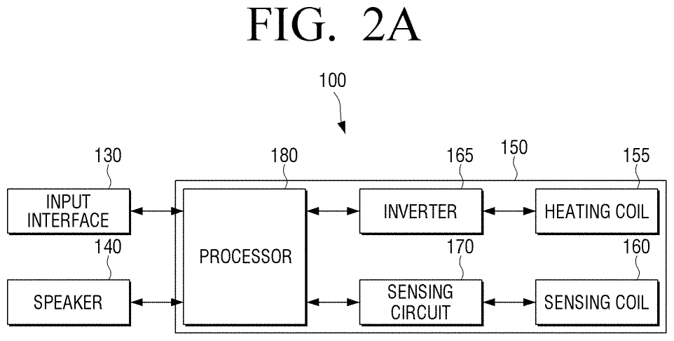

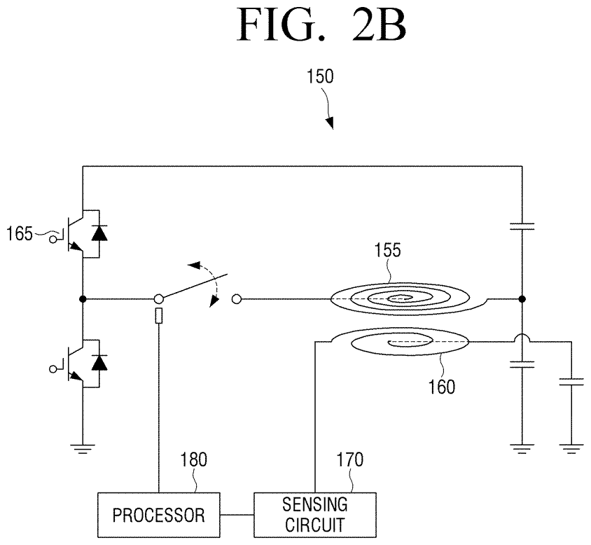

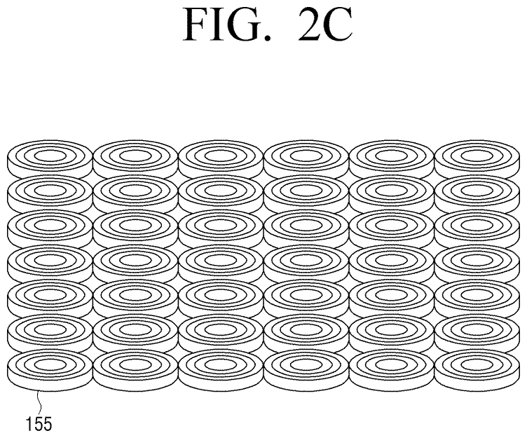

FIG. 2A is a block diagram illustrating a configuration of a cooking apparatus according to an embodiment, FIG. 2B is a diagram illustrating a driving circuit according to an embodiment, and FIG. 2C is a diagram illustrating a disposition of a plurality of heating coils in a grid form according to an embodiment.

Referring to FIG. 2A, the cooking apparatus 100 may include the input interface 130, a speaker 140, and a driving circuit 150. The input interface 130 has been described with reference to FIG. 1 and will not be further described to avoid duplicate description.

The cooking apparatus 100 may include the speaker 140. The speaker 140 may output operation information of the cooking apparatus 100 as a voice. The operation information may include power on/off information, sensing status of the object to be heated, and driving information of induction heating.

The speaker 140, when the object to be heated is placed on an upper portion of the cooking plate of the cooking apparatus 100, may output that the object to be heated is sensed as a voice. The user may identify through the speaker 140 that a preparation for cooking is ready.

If the driving power is applied to the heating coil of the cooking apparatus, the speaker 140 may notify the user of it by a voice. The user may then know, through the speaker 140, that induction heating for cooking began.

Referring to FIG. 2A, a block diagram illustrating the configuration of driving circuit 150 is illustrated. The driving circuit 150 may include a heating coil 155, a sensing coil 160, an inverter 165, a sensing circuit 170, and a processor 180. Each configuration of the driving circuit 150 may be plural, but FIG. 2B illustrates one driving circuit 150 for convenience.

Referring to FIG. 2B, the driving circuit 150 may include the heating coil 155.

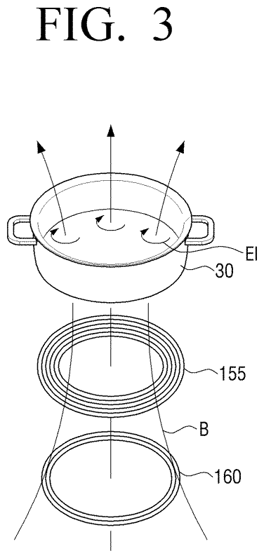

The heating coil 155 may be a main inductor for operating in an induction heating manner. When a driving power is applied to the heating coil 155 and a current according to the driving power is supplied, the heating coil 155 may form a magnetic field. The object to be heated may then be heated by the formed magnetic field. A detailed description of the induction heating will be described below with reference to FIG. 3.

The plurality of heating coils 155 may be arranged in a grid form. Referring to FIG. 2C, an example diagram in which a plurality of heating coils 155 are disposed in a grid form is illustrated. As illustrated in FIG. 2C, the plurality of heating coils 155 may be identical in size. The number windings or number of turns of each heating coil 155 may be the same.

Referring to FIG. 2B, the driving circuit 150 may include the sensing coil 160.

The sensing coil 160 may be a sub-inductor for sensing the object to be heated. The sensing coil 160 may be located at an upper portion or a lower portion of the heating coil 155.

When a test power is applied to the sensing coil 160 and a current according to the test power is supplied, the sensing coil 160 may form a magnetic field. The test power source may be power less than the driving power source, and the current according to the test power may also be a micro current that is less than the current by the driving power source. For example, the test power supply may be a voltage of 8V to 12V.

The sensing coil 160 may form a magnetic field and measure a change in current of the sensing coil 160 by electromagnetic induction phenomenon to sense the object to be heated. A specific description of sensing the object to be heated will be described with reference to FIG. 3.

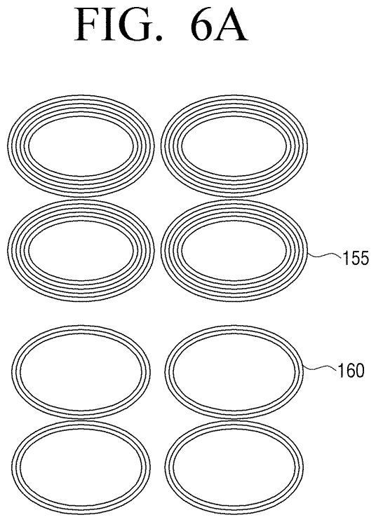

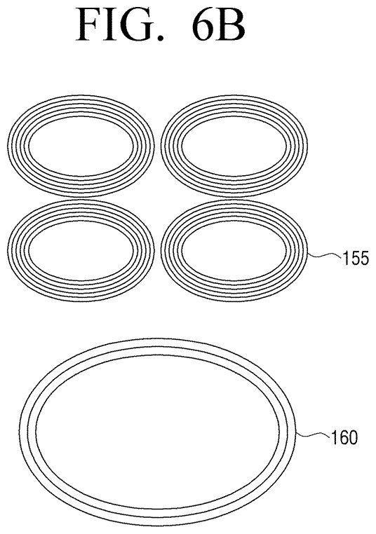

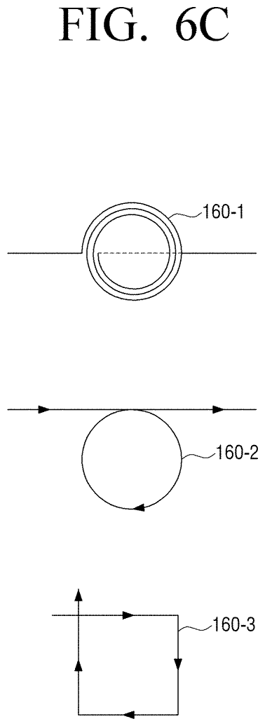

The plurality of sensing coils 160 may be arranged in a grid form. FIG. 2C is an example diagram illustrating that a plurality of heating coils 155 are arranged in a grid form, and a plurality of sensing coils 160 may be arranged in a grid form at the upper or lower portions of the plurality of heating coils 155. The shape, turn number, and winding number of the sensing coil 160 will be described in detail with reference to FIG. 6.

Referring to FIG. 2B, the driving circuit 150 may include an inverter 165. The inverter 165 may provide a driving power to the heating coil. The inverter 165 may be in plural to correspond to each of the plurality of heating coils 155.

An end of the inverter 165 may be connected to the heating coil 155. The inverter 165 may include a switching device, and the inverter 165 and the heating coil 155 may be electrically blocked using a switching device so that the driving power is not applied to the heating coil 155.

The inverter 165 may increase the output of the driving power to increase the heating level of the cooking apparatus. The heating level discretely divides the output of the cooking apparatus, and the higher the heating level is, the higher the driving power the inverter 165 may apply, and the intensity of the magnetic field generated by the driving power source may increase. The higher the intensity of the magnetic field is, the faster the object to be heated may be heated, and the object to be heated may be heated to a higher temperature.

Referring to FIG. 2B, the driving circuit 150 may include the sensing circuit 170. An end of the sensing circuit 170 may be connected to the sensing coil 160, and the other end of the sensing circuit 170 may be connected to the processor 180.

The sensing circuit 170 may provide a test power to one end of the sensing coil 160 and sense the magnitude of the power output from the other end of the sensing coil 160. The test power source provided to the sensing coil 160 may be a smaller power source compared to the driving power source. The sensing circuit 170 may minimize the amount of standby power by applying a test power smaller than the driving power to one end of the sensing coil 160.

The sensing circuit 170 may include an amplifier to sense the magnitude of the power output from the other end of the sensing coil. Here, the amplifier may be an operational amplifier, for example, an operational amplifier (OP-AMP). The sensing circuit 170 may amplify the micro current that is output from the other end of the sensing coil using an amplifier and may easily sense the change of the current.

Referring to FIGS. 2A and 2B, the driving circuit 150 may include the processor 180. The processor 180 may be electrically connected to the input interface 130, the speaker 140, the inverter 165, and the sensing circuit 170 to control the overall operation and function of the cooking apparatus 100. Specifically, the processor 180 may receive an input of a user command including the heating level of the cooking apparatus from the input interface 130 and may perform an operation for processing the received user command. The processor 180 may also control the speaker 140 to provide a voice to the user. The processor 180, connected to the sensing circuit 170, may check the presence of the object to be heated, and control the inverter 165 to apply the driving power.

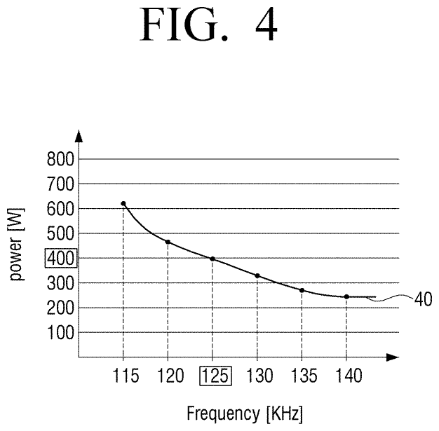

The processor 180 may identify the presence of the object to be heated placed at an upper portion of the sensing coil 160 based on the magnitude of power sensed by the sensing circuit 170 and if the presence of the object to be heated is identified, may control the inverter 165 to apply the driving power to the heating coil 155. The processor 180 may compare the magnitude of the power sensed by the sensing circuit 170 with a reference power value in a predetermined frequency range, and if the magnitude of the sensed power is greater than the reference power value, the processor 180 may identify that an object to be heated is present. The reference power value in the predetermined frequency range will be described in detail below with reference to FIG. 4.

The processor 180 may control the sensing circuit 170 to identify whether the object to be heated is placed while the driving power is applied to the heating coil 155, and if it is identified that the object to be heated is not placed, the processor 180 may control the inverter 165 so that the driving power applied to the heating coil 155 is blocked. If the removal of the placed object to be heated is identified, the processor 180 may block the driving power. When the object to be heated is removed from the upper portion of the sensing coil 160, the current flowing over the heating coil 155 or the sensing coil 160 may be changed. As the change in current results in a change in a calculated power value, the processor 180 may identify whether the object to be heated has been removed based on the changed power value.

The processor 180 may identify a location of the object to be heated placed at the upper portion of the plurality of sensing coils 160 based on the magnitude of power output from the respective other ends of the plurality of sensing coils 160, and may control the inverter so that the driving power is applied to the heating coil corresponding to the identified location of the object to be heated. Referring to FIG. 2C, a plurality of heating coils 155 are illustrated in FIG. 2C, and the sensing coil 160 may be disposed at an upper portion or lower portion the plurality of heating coils 155. If the magnitude of the power changes due to the presence of an object to be heated mounted on the upper portion of the plurality of sensing coils 160, the processor 180 may identify the location of the object to be heated based on the magnitude of the changed power.

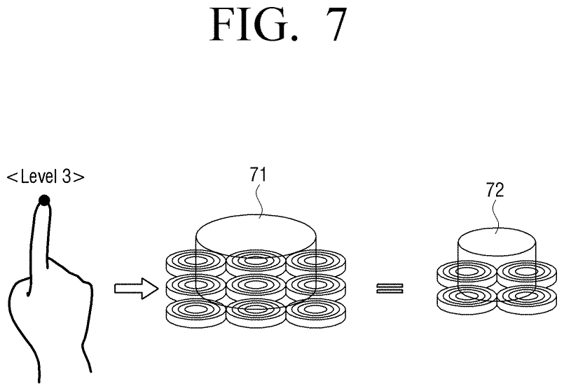

The processor 180 may control the inverter 165 so that the plurality of heating coils 155 corresponding to the identified location of the object to be heated have a specific heating level. An embodiment thereof will be further described with reference to FIG. 7.

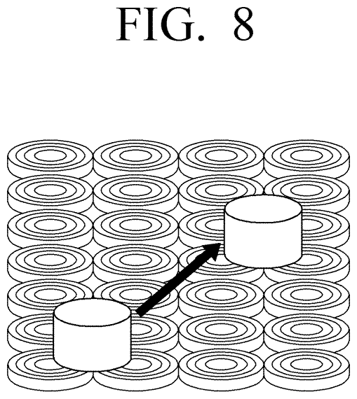

If the identified location of the object to be heated is moved while the driving power is applied, the processor 180 may control the inverter 165 so that the heating coil 155 corresponding to the moved location has the same heating level as before moving. An embodiment thereof will be further specified with reference to FIG. 8.

FIG. 3 is a diagram illustrating a process of sensing and heating an object to be heated of a cooking apparatus according to an embodiment. Referring to FIG. 3, the heating coil 155, the sensing coil 160 disposed at a lower portion of the heating coil, and an object to be heated 30 are illustrated.

The principle of heating and sensing the object to be heated are identical in all the coils, and thus, the description thereof will be provided using one heating coil 155 and one sensing coil 160, for convenience.

The object to be heated 30 may be heated by an induction method by the heating coil 155. Specifically, the heating coil 155 may generate a magnetic field B passing through the inside of the heating coil 155 according to the Ampere's Law when the driving power is supplied to the wound wire. The magnetic field B generated in the heating coil 155 may pass through the bottom surface of the object to be heated 30. Here, the driving power source may be a current of which direction is changed according to time, that is, an alternating current (AC) current.

The magnetic field B passing through the inside of the heating coil 155 may change over time by the driving power source. The magnetic field B generated by the heating coil 155 may change over time, and a current EI rotating around the magnetic field B may be generated by an electromagnetic induction phenomenon in the bottom surface of the object to be heated 30. The electric current rotating around the magnetic field B is a current formed by a voltage generated in a direction to hinder a change in the magnetic field B of the heating coil 155 and may be an eddy current (EI). The object to be heated 30 may have an electrical resistance, and if an EI is generated on the bottom surface of the object to be heated 30, heat may be generated according to Ohm's Law. The object to be heated 30 may be heated in an induction heating manner by the heating coil 155.

The object to be heated 30 may be sensed using a change in the current of the sense coil 160. Specifically, the sensing coil 160 may generate a magnetic field B passing through the inner side of the sensing coil 160 according to Ampere's Law when a test power is supplied to the wound wire. The test power applied to the sensing coil 160 may be an AC measurement voltage of 8V to 12V. When a test power is applied to the sensing coil 160, a micro current of several milliamperes may be generated. When a test power is supplied to the sensing coil 160, the driving power to the heating coil 155 may be blocked.

When the object to be heated 30 is placed on the upper portion of the sensing coil 160, the inductance of the system consisting of the sensing coil 160 and the object to be heated 30 may be reduced compared to the inductance of the sensing coil 160 in the absence of the object to be heated 30. As a result, the resonant frequency of the sensing coil 160 may increase, and the micro current generated in the sensing coil 160 may increase by the test power. The sensing circuit 170 may sense a change in the increased resonant frequency or current, and the processor 180 may identify the presence of the object to be heated 30 based on a change in resonant frequency or current.

Specifically, the processor 180 may calculate the magnitude of the power based on a change in the current sensed by the sensing circuit 170, and compare the magnitude of the calculated power with a reference power value in a predetermined frequency range to confirm the presence of the object to be heated. The reference power value may be a reference for determining whether an object to be heated is present on the upper portion of the sensing coil 160.

FIG. 4 is a diagram illustrating a predetermined reference power value according to an embodiment.

An x-axis of a graph 40 illustrated in FIG. 4 represents a predetermined frequency range of the test power applied to the sensing coil 160, and the predetermined frequency range may be 115 kHz to 140 kHz. A y-axis may refer to a power value sensed by amplifying the power output from the other end of the sensing coil 160 with an amplifier included in the sensing circuit 170. The graph 40 illustrates the magnitude of the power sensed by amplifying the power output from the other end of the sensing coil 160 when a test power of a predetermined frequency range is applied to the sensing coil 160 and the object to be heated is placed on the upper portion of the sensing coil 160. The object to be heated is a magnetic material container for induction heating, and the size of the object to be heated may be an increased size that may be accommodated in the range of the magnetic field B formed in the sensing coil 160. The graph 40 of FIG. 4 is a graph illustrating the magnetic material container of the increased size that may be accommodated in the range of the magnetic field B of the sensing coil 160, so that the predetermined reference power value may be smaller than or equal to the graph 40 illustrated in FIG. 4. For example, in FIG. 4, since the power value is 400 W when the frequency is 125 kHz, the reference power value may be 100 W when the frequency is 125 kHz.

The cooking apparatus 100 may set a range in which a driving power is applied to the heating coil 155 using a predetermined reference power value. For example, the reference power value may be set to be higher than the power value when a foreign object which should not be heated such as a spoon and chopsticks is disposed on an upper part of the sensing coil 160 and set to be lower than the power value when a part (e.g. ¼) or more of a magnetic material container is included.

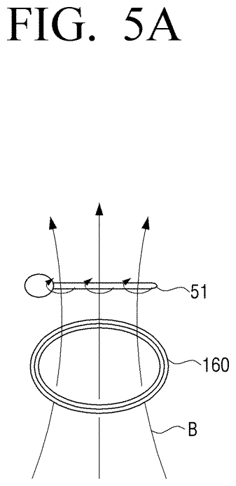

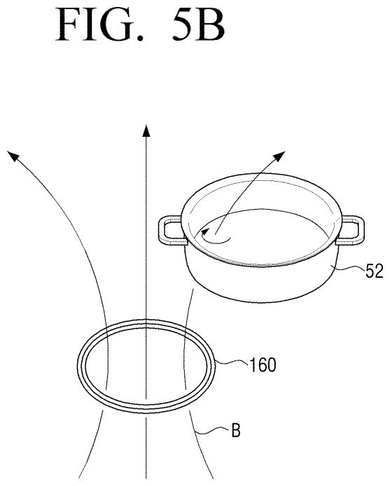

Referring to FIG. 5A, a foreign object 51 is placed on the sensing coil 160. The induced current may be formed inside the foreign object 51 by the magnetic field B formed in the sensing coil 160, and the inductance of the sensing coil 160 may be changed by the formed induced current, and the micro current that is output from the other end of the sensing coil 160 may be changed. The influence of the foreign object 51 on the sensing coil 160 may be insignificant compared to a case in which the object to be heated is a magnetic container. The cooking apparatus 100 may control the inverter 165 so as not to apply the driving power to the heating coil 155 when the object to be heated is the foreign object 51 by setting a predetermined reference power value to a predetermined value or higher.

The cooking apparatus 100 may identify that the object to be heated is a foreign object based on the output power value of the other end of the sensing coil 160 when the object to be heated is the foreign object 51 including a spoon and chopsticks. In an example where the foreign object 51 is disposed, the cooking apparatus 100 may notify the user that the foreign object 51 is placed using the speaker 140 and may not apply the driving power to the heating coil 155.

Referring to FIG. 5B, the object to be heated 52 is placed at an upper portion of the sensing coil 160.

A plurality of sensing coils 160 may be disposed in the form of a grid, and the object to be heated 52 may be placed on an upper portion of the plurality of sensing coils 160 disposed in the form of a grid. According to the type that the object to be heated 52 is placed, as shown in FIG. 5B, a portion of the object to be heated 52 may be disposed on the sensing coil 160. When the driving power is applied to all the heating coils 155 in the lower portion of the object to be heated 52 while the cooking apparatus 100 operates, excessive power may be wasted. The cooking apparatus 100 may set the reference power value to a power value sensed by the sensing circuit when a part (e.g., ¼) of the object to be heated 52 is included, for avoiding waste of power and operational efficiency.

FIGS. 6A and 6B are diagrams illustrating the number of sensing coils and heating coils according to an embodiment; and FIG. 6C is a diagram illustrating a form of a sensing coil according to an embodiment.

Referring to FIG. 6A, a plurality of heating coils 155 and a plurality of sensing coils 160 disposed below the heating coil are illustrated. The cooking apparatus 100 may include a plurality of heating coils 155 and a plurality of sensing coils 160, and the plurality of heating coils 155 and the plurality of sensing coils 160 may be arranged in a grid form. The number of the sensing coils 160 is equal to the number of the heating coils 155, and each of the sensing coils 160 may correspond to the different heating coils 155.

Since each sensing coil 160 may correspond to different heating coils 155, the cooking apparatus 100 may identify the location of the object to be heated mounted on the upper portion of the plurality of sensing coils 160 based on the magnitude of the power output from each other end of the plurality of sensing coils 160, and apply the driving power to the heating coil 155 corresponding to the identified location of the object to be heated. Referring to FIG. 6A, four heating coils 155 and four sensing coils 160 are illustrated, but this is for convenience, and the number of the heating coil 155 and the sensing coil 160 are not limited thereto.

Referring to FIG. 6B, a plurality of heating coils 155 and one sensing coil 160 disposed below the heating coil are illustrated. The cooking apparatus 100 may include a plurality of heating coils 155 and a plurality of sensing coils 160, and the plurality of heating coils 155 and the plurality of sensing coils 160 may be arranged in a grid form. The number of sensing coils 160 may be less than the number of heating coils 155. As illustrated in FIG. 6B, one sensing coil 160 may be disposed at a lower portion of the four different heating coils 155. Each of the sensing coils 160 is arranged such that the different heating coils 155 do not overlap, and that four different heating coils 155 may correspond to one sensing coil 160.

Referring to FIG. 6C, the sensing coil 160 in a spiral, circular, and polygonal shape is illustrated.

The sensing coil 160 may be a subsidiary working inductor to sense the object to be heated. The sensing coil 160 may be located at an upper portion or a lower portion of the heating coil 155. If the test power is applied, and the micro current is supplied according to the test power, the sensing coil 160 may form magnetic field. Here, the test power may be smaller power compared to the driving power. By using the test power that is smaller than the driving power, the standby power may be reduced significantly. The sensing coil 160, along with the sensing circuit 170, may implement the low power sensing circuit and control algorithm capable of rapidly sensing the location and size of the object to be heated located at an upper portion of the sensing coil 160.

A plurality of sensing coils 160 may be disposed in a grid form, wherein each sensing coil 160 may include one of a spiral shape 160-1, a circular shape 160-2, and a polygonal shape 160-3. The number of windings or turns of each of the sensing coil 160 may be formed to be less than or equal to the number of turns of the heating coil 155. As illustrated in FIG. 6C, when the number of turns of the sensing coil 160 is a one (1) turn, the object to be heated may be sensed.

FIG. 7 is a diagram illustrating a driving power applied differently by the magnitude of the object to be heated according to an embodiment.

Referring to FIG. 7, the heating level of the cooking apparatus is input, and the driving power is applied so that the heating coil corresponding to the location and size of the object to be heated 71, 72 has an input heating level.

The processor 180 may identify the location of the object to be heated mounted on the upper portion of the plurality of sensing coils based on the magnitude of the power output at each end of the plurality of sensing coils 160. The processor 180 may then estimate the size of the object to be heated based on the location of the identified object to be heated 71, 72. If the presence of the object to be heated is identified, the input interface 130 may receive a heating level associated with the intensity of the driving power to be applied to the heating coil 155.

The heating level discretely divides the output of the cooking apparatus 100, and the higher the heating level, the higher the driving power, and the intensity of the magnetic field generated by the driving power source may increase. The higher the intensity of the magnetic field, the faster the object to be heated may be heated, and the object to be heated may be heated to a higher temperature.

The processor 180 may determine the intensity of the driving power based on the heating level of the cooking apparatus which the input interface 130 has received. The processor 180 may calculate the number of heating coils corresponding to the location and size of the identified object to be heated among the plurality of heating coils 155. The processor 180 may calculate a driving power to be applied to each heating coil based on the number of corresponding heating coils and control the inverter 165 so that the calculated driving power is applied to each heating coil.

Since the heating level discretely divides the output of the cooking apparatus 100, the magnitude of the driving power applied to each heating coil may be different according to the size of the object to be heated. For example, if the user inputs the heating level of the cooking apparatus 100 as <Level 3>, the number of heating coils corresponding to the object to be heated 71 having a large size may be nine, and the number of heating coils corresponding to the object to be heated 72 having a small size may be four. In this example, the driving power applied to each heating coil 155 corresponding to the object to be heated 71 having a large magnitude in order to operate the cooking apparatus 100 with the same heating level may be smaller than the driving power applied when the object to be heated 72 having a small size is mounted.

FIG. 8 is a diagram illustrating that a location of the object to be heated is moved according to an embodiment.

Referring to FIG. 8, the object to be heated being heated is moved to another location. The cooking apparatus 100 is capable of continuously heating the object to be heated at the same heating level as before being moved even when the position of the object to be heated is moved while the object to be heated is heated by the induction heating. Specifically, when the object to be heated present in the upper portion of the plurality of sensing coils 160 is moved, the current flowing in the heating coil 155 or the sensing coil 160 corresponding to the position of the object to be heated may be changed. If the current changes, the cooking apparatus 100, the output power value changes as well, and the cooking apparatus 100 may identify whether the object to be heated has been moved based on the changed power value.

As another embodiment, the cooking apparatus 100 may generate the moving path of the object to be heated identified based on the power value output from the respective other ends of the plurality of sensing coils 160. If moving of the object to be heated stops, the cooking apparatus 100 may apply the driving power so that the heating coil 155 corresponding to the location of the object to be heated has the same heating level as before being moved.

In another embodiment, the cooking apparatus 100 may determine (or identify) that the object to be heated is moved, while the driving power is applied to the heating coil 155, if the removal of the object to be heated placed at an upper portion of the sensing coil 160 is identified and the presence of the object to be heated is identified in another sensing coil 160 within a predetermined time (e.g., three seconds). The cooking apparatus 100 may apply the same driving power to the heating coil 155 corresponding to the moved position so as to have the same heating level when the object to be heated is moved.

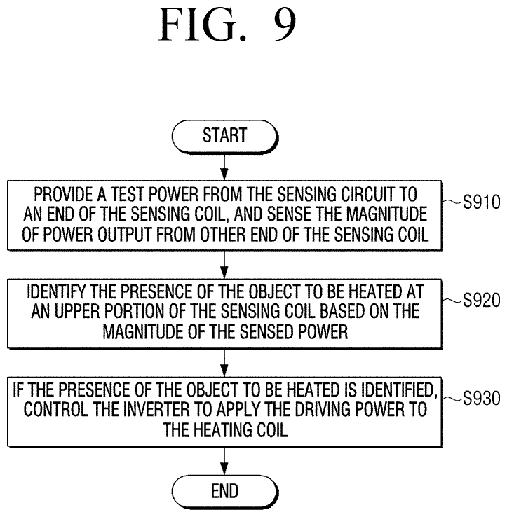

FIG. 9 is a flowchart illustrating a controlling method of a cooking apparatus according to an embodiment.

According to an embodiment, the method for controlling the cooking apparatus 100 including the heating coil 155 and the sensing coil 160 may include providing a test power from the sensing circuit 170 to an end of the sensing coil 160, and sensing the magnitude of power output from other end of the sensing coil 160 in operation S910. Here, the test power may be less power than the driving power source, and the current according to the test power may also be a micro current that is less than the current by the driving power source. For example, the test power may be a voltage of 8V to 12V.

The cooking apparatus 100 may identify the presence of the object to be heated placed at an upper portion of the sensing coil 160 based on the magnitude of the power sensed by the sensing circuit 170 in operation S920. The cooking apparatus 100 may compare the magnitude of power sensed by the sensing circuit 170 with the reference power value in the predetermined frequency range, and if the sensed magnitude of power is greater than the reference power value, the cooking apparatus 100 may identify that the object to be heated is present.

If the presence of the object to be heated is identified, the cooking apparatus 100 may apply the driving power to the heating coil in operation S930. The plurality of sensing coils 160 and the plurality of heating coils 155 may be disposed in a grid form, and the cooking apparatus 100 may apply the driving power to the heating coil 155 corresponding to the location of the object to be heated.

While the driving power is applied to the heating coil 155, if the removal of the object to be heated placed at an upper portion of the sensing coil 160 is identified, the cooking apparatus 100 may control the inverter 165 to block the driving power applied to the heating coil 155.

Although the present disclosure has been described with various embodiments, various changes and modifications may be suggested to one skilled in the art. It is intended that the present disclosure encompass such changes and modifications as fall within the scope of the appended claims.

What is claimed is:

1. A cooking apparatus comprising:
a heating coil operable by an induction heating method;
an inverter configured to provide a driving power to the heating coil;
a sensing coil positioned at an upper portion or a lower portion of the heating coil;
a sensing circuit configured to provide a test power to an end of the sensing coil and sense a magnitude of power that is output at other end of the sensing coil; and
a processor configured to:
identify whether an object to be heated is disposed at an upper portion of the sensing coil based on the magnitude of power sensed by the sensing circuit, and
based on the disposition of the object to be heated being identified, control the inverter to apply the driving power to the heating coil.

2. The cooking apparatus of claim 1, wherein the processor is further configured to, based on the magnitude of power sensed by the sensing circuit exceeding a reference power value in a predetermined frequency range, determine that the object to be heated is disposed.

3. The cooking apparatus of claim 1, wherein the processor is further configured to:
control the sensing circuit for identifying whether the object to be heated is disposed while the driving power is applied to the heating coil; and
based on identification that the object to be heated is not disposed, control the inverter to block the driving power applied to the heating coil.

4. The cooking apparatus of claim 1, wherein:
the heating coil is configured such that a plurality of heating coils are disposed in a grid form, and
the sensing coil is configured such that a plurality of sensing coils are disposed in a grid form.

5. The cooking apparatus of claim 4, wherein:
a number of the plurality of sensing coils is identical with a number of the plurality of heating coils, and
each sensing coil of the plurality of sensing coils is disposed at an upper portion or a lower portion of a corresponding heating coil of the plurality of heating coils.

6. The cooking apparatus of claim 4, wherein:
a number of the plurality of sensing coils is less than a number of the plurality of heating coils, and
each sensing coil of the plurality of sensing coils is disposed at an upper portion or a lower portion of different heating coils of the plurality of heating coils such that the different heating coils do not overlap with each other.

7. The cooking apparatus of claim 4, wherein the processor is further configured to:
identify a location of the object to be heated based on the magnitude of power that is output from each other end of the plurality of sensing coils; and
control the inverter so that a driving power is applied to the heating coil corresponding to the identified location of the object to be heated.

8. The cooking apparatus of claim 7, further comprising an input interface configured to receive an input of a heating level of the cooking apparatus,
wherein the processor is further configured to:
calculate driving power for each of the plurality of heating coils so that each of a plurality of corresponding heating coils of the plurality of heating coils corresponding to the identified location of the object to be heated have the input heating level, and
control the inverter so that the calculated driving power is applied to each of the plurality of corresponding heating coils.

9. The cooking apparatus of claim 8, wherein the processor is further configured to, based on the identified location of the object to be heated moving to a moved location while the calculated driving power is applied, control the inverter to cause the heating coil corresponding to the moved location to have a same heating level as before the object to be heated is moved.

10. The cooking apparatus of claim 1, wherein the sensing coil is in one of a spiral, circular, or polygonal shape.

11. The cooking apparatus of claim 1, wherein the sensing coil is formed with a number of turns that are less than or equal to a number of turns of the heating coil.

12. A method for controlling a cooking apparatus comprising a heating coil and a sensing coil, the method comprising:
providing a test power from a sensing circuit to an end of the sensing coil and sensing a magnitude of power that is output at other end of the sensing coil;
identifying whether an object to be heated is disposed at an upper portion of the sensing coil based on the magnitude of power sensed by the sensing circuit; and
based on the disposition of the object to be heated being identified, applying a driving power to the heating coil.

13. The method of claim 12, wherein the identifying comprises, based on the magnitude of power sensed by the sensing circuit exceeding a reference power value in a predetermined frequency range, determining that the object to be heated is disposed.

14. The method of claim 12, further comprising:
identifying whether the object to be heated is disposed while the driving power is applied to the heating coil; and
based on identification that the object to be heated is not disposed, blocking the driving power applied to the heating coil.

15. The method of claim 12, wherein:
the heating coil is configured such that a plurality of heating coils are disposed in a grid form, and
the sensing coil is configured such that a plurality of sensing coils are disposed in a grid form.

16. The method of claim 15, wherein:
a number of the plurality of sensing coil is identical with a number of the plurality of heating coils, and
each sensing coil of the plurality of sensing coils is disposed at an upper portion or a lower portion of a corresponding heating coil of the plurality of heating coils.

17. The method of claim 15, wherein:
a number of the plurality of sensing coil is less than a number of the plurality of heating coils, and
each sensing coil of the plurality of sensing coils is disposed at an upper portion or a lower portion of different heating coils of the plurality of heating coils such that the different heating coils do not overlap with each other.

18. The method of claim 15, wherein the applying comprises:
identifying a location of the object to be heated based on the magnitude of power that is output from each other end of the plurality of sensing coils; and
applying a driving power to the heating coil corresponding to the identified location of the object to be heated.

19. The method of claim 18, further comprising receiving an input of a heating level of the cooking apparatus,
wherein the applying comprises:
calculating driving power for each of the plurality of heating coils so that each of a plurality of corresponding heating coils of the plurality of heating coils corresponding to the identified location of the object to be heated have the input heating level, and
applying the calculated driving power to each of the plurality of corresponding heating coils.

20. The method of claim 19, wherein the applying comprises, based on the identified location of the object to be heated moving to a moved location while the calculated driving power is applied, applying the driving power to cause the heating coil corresponding to the moved location to have a same heating level as before the object to be heated is moved.
